(19) United States
(12) Patent Application Publication
(10) Pub. No.: US 2010/0171947 A1
(43) Pub. Date: Jul. 8, 2010

(54) PATTERN INSPECTION DEVICE AND METHOD

(76) Inventor: Kiminori YOSHINO, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/639,348

(22) Filed: Dec. 16, 2009

(30) Foreign Application Priority Data
Jan. 8, 2009 (JP) 2009-2633

(51) Int. Cl. G01N 21/88

(52) U.S. Cl. 356/237.5

(57) ABSTRACT

A pattern inspection device has a light irradiator configured to irradiate a light on an inspection area set in a pattern forming location on a semiconductor wafer and an adjustment area set different from the inspection area in association with the inspection area on the semiconductor wafer, an image pickup part for inspection configured to pick up a light which is irradiated by the light irradiator and reflected on the inspection area to generate an inspection image, a tester configured to conduct a pattern inspection of the semiconductor wafer based on the inspection image, an image pickup part for adjustment configured to pick up a light which is irradiated by the light irradiator and reflected on the adjustment area to generate an adjustment image, and a light amount adjuster configured to adjust an amount of the light irradiated on the inspection area by the light irradiator so as to reduce a fluctuation of a luminance of the inspection image due to a difference of a thickness of the pattern based on the adjustment image.

### CROSS REFERENCE TO RELATED APPLICATIONS

This application is based upon and claims the benefit of priority from the prior Japanese Patent Applications No. 2009-2633, filed on Jan. 8, 2009, the entire contents of which are incorporated herein by reference.

### BACKGROUND OF THE INVENTION

1. Field of the Invention

This invention relates to a pattern inspection device and a method for detecting pattern defects based on a reflected light of a light irradiated on a semiconductor wafer.

2. Related Art

A pattern inspection device is used in order to inspect pattern defects formed on a semiconductor device. The pattern inspection device irradiates the semiconductor wafer with a light to obtain the reflected light as an inspection image and to compare the inspection image with a reference image, thereby detecting pattern defects such as open, short and mixture of foreign materials. It is necessary to adjust both of focus and luminance (amount of the light) irradiated on the semiconductor wafer in order to compare the images precisely. If out of focus, edges of the pattern become unclear, and it will be difficult to precisely compare the inspection image with the reference image. In general, the pattern inspection device has an auto focus function and can adjust the focus automatically. On the other hand, if the adjustment of the amount of the light is improper, there is a likelihood that the luminance of the inspection image also becomes improper, thereby causing detection missing and false defect for inspection. Here, the detection missing means that, for example, black foreign materials are not detected when the inspection image is too dark. The false defect means that, for example, when the luminance of the inspection image is extremely different from that of the reference image, even if there are no defects, the pattern inspection device erroneously determines that defects are present.

In general, when the pattern inspection is conducted at multiple locations on the semiconductor wafer, the adjustment of the amount of the light is performed based on an inspection image at only a first location or first few locations. The subsequent pattern inspections are conducted using the adjusted constant amount of the light. However, the luminance of the inspection image is not necessarily the same because reflectance ratios vary depending on the inspected location. Therefore, there is a likelihood that the detection missing of the pattern defects and the false defects occur if the pattern inspection is conducted with the constant amount of the light.

JP-A No. 2003-121367 (Kokai) discloses a technique in which the amount of the light is adjusted by using a camera different from that for the pattern inspection to keep the luminance of the inspection image for inspection to be constant. However, because the camera used for only adjusting the amount of the light is necessary, there are problems that the pattern inspection device is enlarged and the cost thereof increases.

### SUMMARY

According to one aspect of the present invention, a pattern inspection device comprising: a light irradiator configured to irradiate a light on an inspection area set in a pattern forming location on a semiconductor wafer and an adjustment area set different from the inspection area in association with the inspection area on the semiconductor wafer; an image pickup part for inspection configured to pick up a light which is irradiated by the light irradiator and reflected on the inspection area to generate an inspection image; a tester configured to conduct a pattern inspection of the semiconductor wafer based on the inspection image; an image pickup part for adjustment configured to pick up a light which is irradiated by the light irradiator and reflected on the adjustment area to generate an adjustment image; and a light amount adjuster configured to adjust an amount of the light irradiated on the inspection area by the light irradiator so as to reduce a fluctuation of a luminance of the inspection image due to a difference of a thickness of the pattern based on the adjustment image.

According to the other aspect of the present invention, a pattern inspection method comprising: irradiating a light on an inspection area set in a pattern forming location on a semiconductor wafer and an adjustment area set different from the inspection area in association with the inspection area on the semiconductor wafer; picking up the irradiated light reflected on the inspection area to generate an inspection image; conducting a pattern inspection of the semiconductor wafer based on the inspection image; picking up the irradiated light reflected on the adjustment area to generate an adjustment image; and adjusting an amount of the irradiated light so as to reduce a fluctuation of a luminance of the inspection image due to a difference of a thickness of the pattern based on the adjustment image.

### BRIEF DESCRIPTION OF THE DRAWINGS

FIG. 1 is a schematic diagram showing a pattern inspection system having a pattern inspection device 100 according to a first embodiment of the present invention.

FIG. 2 is a flowchart showing an example of processing operation of the pattern inspection device 100.

FIG. 3 is a flowchart showing an example of detailed operation of step S1.

FIG. 4 is an explanatory drawing showing a positional relationship between an inspection area and an adjustment area.

FIG. 5A and FIG. 5B are examples of graphs showing a correlative relationship between luminance information “x” of an adjustment image and luminance information “y” of an inspection image.

FIG. 6 is an example of a graph showing the correlative relationship between the luminance information “y” of the inspection image and an irradiation amount of the light “z” for the inspection on a plurality of different areas for the test.

FIG. 7 is a pattern diagram showing a film formed on a wafer 101.

FIG. 8 is a graph showing an example of a relationship between the thickness of the film “d” and a reflectance ratio.

FIGS. 9A and 9B are graphs showing examples of correlative relationships between the luminance information “x” of the adjustment image and the irradiation amount of the light “z” for the inspection.

FIG. 10 is a graph showing an example of a relationship between a focus state and the luminance information “x” of the adjustment image.

FIG. 11 is a schematic diagram showing one example of a pattern inspection system having a pattern inspection device 100 according to a second embodiment of the present invention.

FIG. 12 is a schematic diagram showing a pattern inspection system having a pattern inspection device 100 according to a third embodiment of the present invention.

FIG. 13 is a schematic diagram showing a pattern inspection system having a pattern inspection device 100 according to a fourth embodiment of the present invention.

### DETAILED DESCRIPTION OF THE INVENTION

Hereinafter, the present embodiments of a pattern inspection device and a pattern inspection method will be explained with reference to accompanying drawings.

### First Embodiment

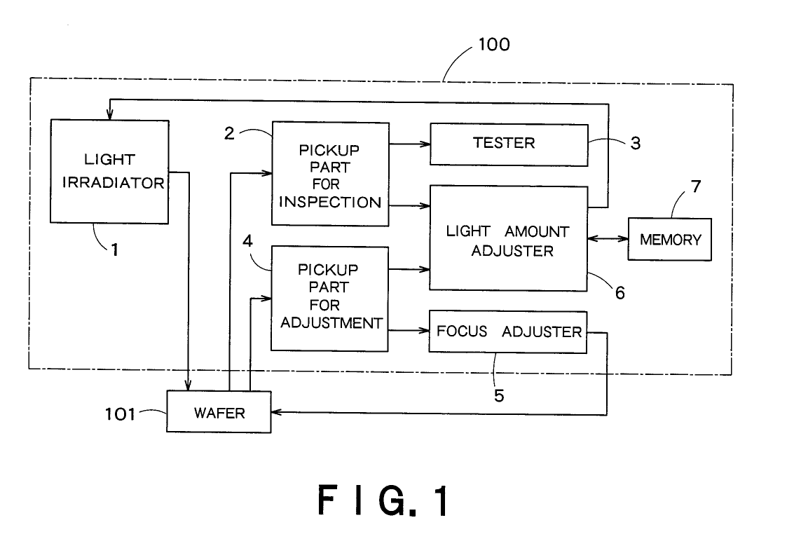

FIG. 1 is a schematic diagram showing a pattern inspection system having a pattern inspection device 100 according to a first embodiment of the present invention. The pattern inspection device 100 has a light irradiator 1, a pickup part 2 for inspection, a tester 3, a pickup part 4 for adjustment, a focus adjuster 5, a light amount adjuster 6, and a memory 7.

The light irradiator 1 irradiates an inspection area and an adjustment area on an inspected semiconductor wafer (hereinafter, wafer) 101 with a light. The pickup part 2 for inspection picks up a light reflected on the inspection area on the wafer to generate an inspection image. The tester 3 compares the inspection image with a reference image to detect pattern defects of the wafer 101. The pickup part 4 for adjustment picks up a light reflected on the adjustment area to generate an adjustment image. The focus adjuster 5 adjusts the focus of the adjustment image. The light amount adjuster 6 adjusts the amount of the light irradiated on the wafer 101 by the light irradiator 1. The memory 7 stores correlative relationships and an irradiation amount of the light for the inspection which will be explained below.

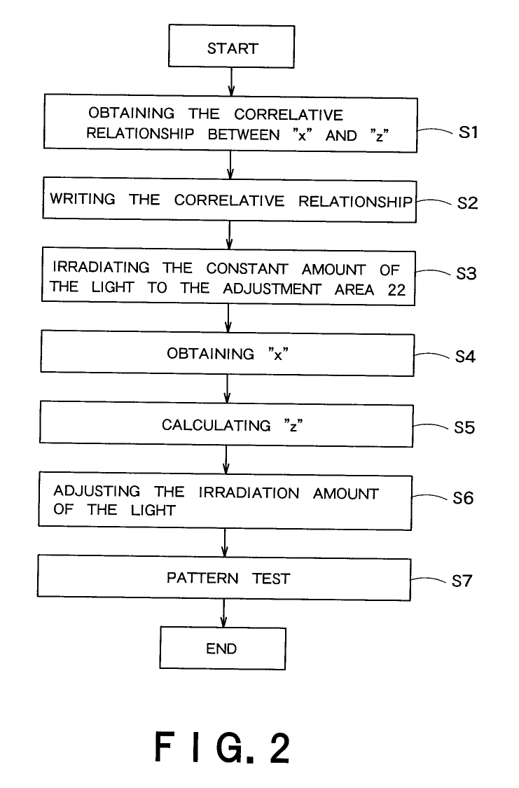

FIG. 2 is a flowchart showing an example of processing operation of the pattern inspection device 100. FIG. 2 assumes that the pattern inspection is conducted successively at a plurality of locations having the same pattern on the wafer in FIG. 2. The adjustment image generated by the pickup part 4 for adjustment is used not only for the focus adjustment, but for the light-amount adjustment. Therefore, it is unnecessary to separately provide an image pickup part for the light-amount adjustment. Hereinafter, the way for adjusting the amount of the light, which is one of the characteristic features of the present embodiment, will be mainly explained.

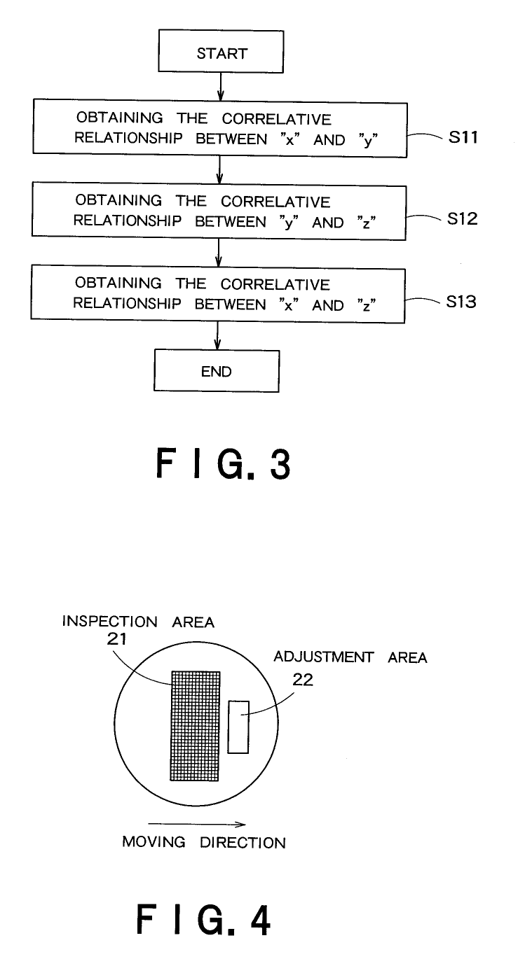

Firstly, when the inspection recipe is generated before starting the pattern inspection, the light amount adjuster 6 obtains a correlative relationship between luminance information “x” of the adjustment image and irradiation amount of the light “z” for the inspection (step S1). FIG. 3 is a flowchart showing an example of detailed operation of step S1. Hereinafter, step S1 will be described in detail.

The light amount adjuster 6 obtains a correlative relationship (first correlative relationship) between the luminance information “x” of the adjustment image generated based on the light reflected on the adjustment area on the wafer 101 and luminance information “y” of the inspection image generated based on the light reflected on the inspection area (step S11). Here, the luminance information indicates luminance of each of the images, such as an average luminance of each of the images. The luminance information can be a luminance value itself or be a digital value corresponding to the luminance value when the images are expressed by digital signals.

FIG. 4 is an explanatory drawing showing a positional relationship between the inspection area and the adjustment area on the wafer 101. The inspection area 21 corresponds to the inspection image, and the adjustment area 22 corresponds to the adjustment image in FIG. 4. The circle in FIG. 4 represents a spot of the light irradiated by the light irradiator 1. The adjustment area 22 is set ahead of the inspection area 21 in the moving direction on the wafer 101 of the pattern inspection device 100. The reason to set the adjustment area 22 ahead of inspection area 21 is that the focus adjustment and the light-amount adjustment are firstly performed using the adjustment area 22 without stopping the move of the wafer 101 firstly, and then the pattern inspection is conducted using inspection area 21 successively. As mentioned above, the light amount adjuster 6 generates the adjustment image required for the focus adjustment and the light-amount adjustment before the pattern inspection. The inspection area 21 and the adjustment area 22 are set in consideration of the moving speed of the wafer 101 and the time for adjusting the focus and adjusting the amount of the light.

It is preferable that inspection area 21 is set larger than the adjustment area 22. This is because if the spot of the light irradiated at the inspection is large (e.g. 500 μm) and the image reflected from inside of the spot having less fluctuation of the light is used, it is possible to precisely conduct the pattern inspection. Furthermore, as the spot of the light is larger, a time required for inspecting can be shortened.

Although only a pair of the inspection area 21 and the adjustment area 22 is shown in FIG. 4, a plurality of the inspection areas 21 having the same pattern are provided in a chip because a plurality of the same chips are formed on the wafer 101 practically. Furthermore, because a plurality of the same patterns can be formed in a chip, a plurality of the inspection areas 22 can be provided in a chip. Each of the areas for the adjustment 22 is provided corresponding to each of the areas for the inspection 21. The adjustment area 22 can be formed on the location where the pattern is formed or can be formed on the location where the pattern is not formed.

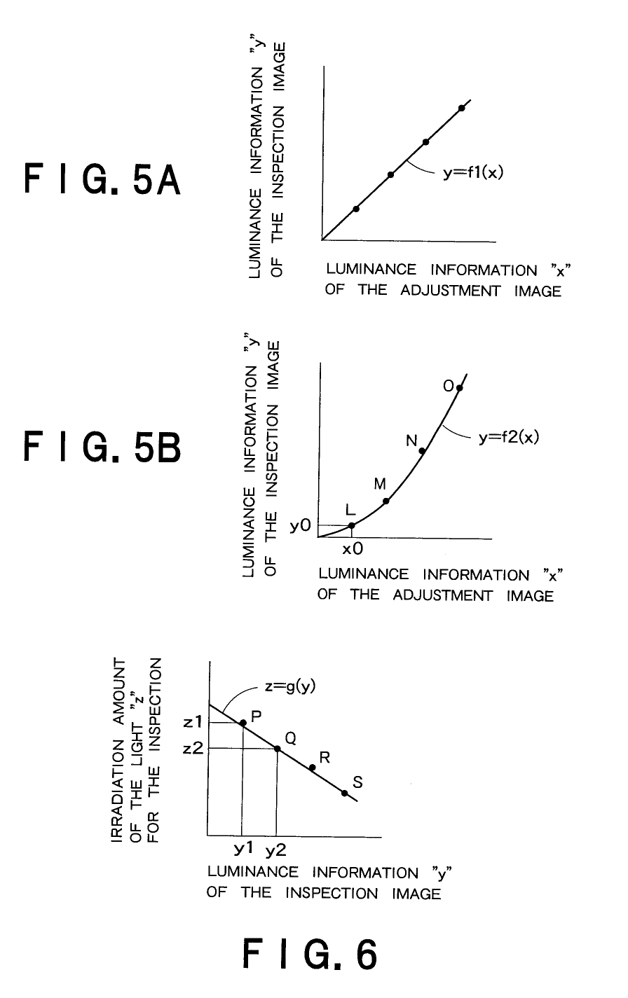

FIG. 5A and FIG. 5B are examples of graphs showing the correlative relationship between the luminance information “x” of the adjustment image and the luminance information “y” of the inspection image. The horizontal axis is the luminance information “x” of the adjustment image, and the vertical axis is the luminance information “y” of the inspection image. In FIG. 5A and FIG. 5B, the relationships between “x” and “y” are expressed as y=f1(x) and y=f2(x), respectively. Step S11 will be explained more specifically with reference to FIG. 5B. Firstly, the light irradiator 1 irradiates the adjustment area 22 with the light of a certain amount L. Then, the light amount adjuster 6 obtains the luminance information “x0” of the adjustment image. Next, the light irradiator 1 irradiates the inspection area 21 with the light of the same amount L. Then, the light amount adjuster 6 obtains the luminance information “y0” of the inspection image. Thus, a point (x0, y0) is plotted. By changing the amount of the light irradiated by the light irradiator 1 in a stepwise manner such as M, N and O to obtain the luminance information of the inspection image and of the adjustment image, the correlative relationship of FIG. 5B is obtained.

In FIG. 5A, the relationship between the “x” and “y” is linear, while as shown in FIG. 5B, the relationship can be nonlinear. This is because, for example, in the case where an image pickup device having the pickup part 4 for adjustment (not shown in FIG. 1) is cheaper than an image pickup device having the pickup part 2 for inspection (not shown), characteristics of both image pickup devices may be different.

The shapes of the graphs in FIG. 5A and FIG. 5B are different. However, both graphs have the same property in that, as the luminance of the adjustment image becomes higher, that of the inspection image becomes higher. This means that the luminance of the inspection image can be calculated according to the luminance of the adjustment image.

Here, in FIG. 5A and FIG. 5B, the correlative relationship is obtained by plotting four points. However, the number of the points is not limited.

Next, the light amount adjuster 6 obtains a correlative relationship (second correlative relationship) between the luminance information “y” of the inspection image and the irradiation amount of the light “z” for the inspection (Step S12). FIG. 6 is an example of a graph showing the correlative relationship between the luminance information “y” of the inspection image and the irradiation amount of the light “z” for the inspection on a plurality of different inspection areas. The horizontal axis is the luminance information “y” of the inspection image, and the vertical axis is the irradiation amount of the light “z” for the test. In FIG. 6, the relationships between “y” and “z” is expressed as z=g(y).

Hereinafter, Step S12 will be explained more specifically with reference to FIG. 6. Firstly, the light irradiator 1 irradiates one of the inspection areas 21 (hereinafter, referred to as inspection area P) with a constant amount of light for the adjustment, and the light amount adjuster 6 obtains a luminance information “y1” of the inspection image. Then, the light amount adjuster 6 adjusts the amount of the light irradiated on the inspection area P and obtains the amount of the light (the irradiation amount of the light for the test) “z1” when the luminance information of the inspection image coincides with a predetermined target value. Thus, the point (y1, z1) is plotted. The correlative relationship of FIG. 6 is obtained by acquiring the amount of the light at a plurality of inspection areas such as Q, R and S irradiated by the light irradiator 1. The correlative relationship of FIG. 6 shows that when the luminance information of the inspection image is “y” when the light irradiator 1 irradiates the inspection area 21 with the above constant amount of the light, the amount of the light can be g(y) for the pattern inspection.

The target value is a luminance information value (luminance) of the inspection image capable of avoiding the occurrence of detection missing of the pattern defects and false defect when the pattern inspection is conducted.

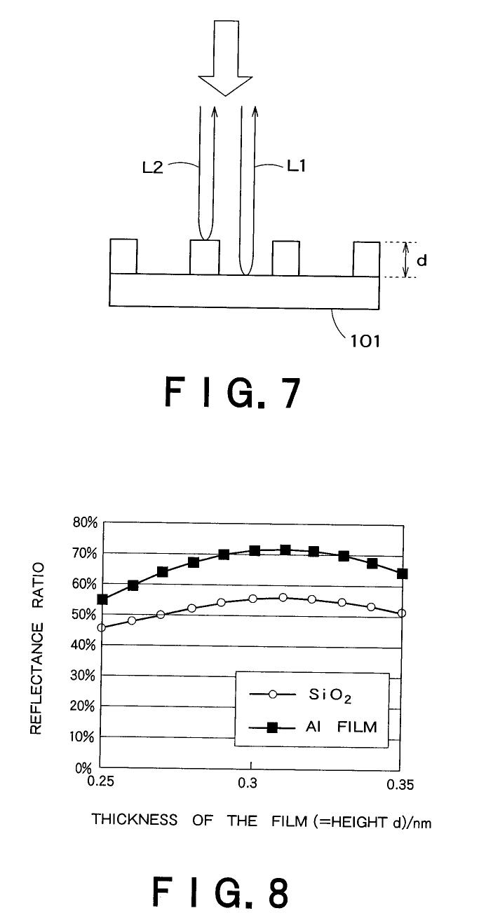

Here, as shown in FIG. 6, although the above constant amount of the light is irradiated on the inspection areas P to S having the same pattern, the luminance information “y” of the inspection image is not necessarily constant (e.g. the luminance information is “y1” at the inspection area P and “y2” at the inspection area Q). Therefore, the irradiation amount of the light “z” for the inspection has to be adjusted (e.g. the irradiation amount is “z1” at the inspection area P and “z2” at the inspection area Q). The main reason will be explained below. FIG. 7 is a pattern diagram showing a film formed on the wafer 101. There is a fluctuation in the thickness of the film “d” between wafers or chips even if the patterns in the wafers or chips are the same. In accordance with the relationship between the thickness of the film “d” and the wavelength of the irradiated light, when light L1 reflected on the surface of the wafer 101 and light L2 reflected on that of the film are strengthened each other, the inspection image becomes bright and when weekend each other, the inspection image becomes dark. Because the thickness of the film “d” varies depending on the location on the wafer 101, the luminance information of the inspection image is not necessarily constant even if the constant amount of the light is irradiated.

FIG. 8 is a graph showing an example of the relationship between the thickness of the film “d” and the reflectance ratio. The graph of FIG. 8 is obtained by simulation in the case where the irradiated light is a Kohler illumination having a UV (ultra violet) light source of wavelength 365 nm, and a single film of silicon dioxide (SiO₂) and a single film of aluminum (Al) are used. In the case of the aluminum film, when the thicknesses of the film “d” are 0.25 nm and 0.3 nm, the reflectance ratios are approximately 55% and 72%, respectively, and the difference is approximately 17%. In general, not a single film, but a plurality of films are formed, and each of the thicknesses of the films can fluctuate. Therefore, the reflectance ratio of the light can fluctuates more than that shown in FIG. 8.

The luminance information “y” of the inspection image obtained by irradiating the above constant amount of the light corresponds to the reflectance ratio of the light on the irradiated inspection area. The example of FIG. 6 shows y1<y2, and therefore that the reflectance ratio of the light on the inspection area P is lower than that on the inspection area Q. Thus, it is shown that as the luminance information “y” of the inspection image obtained by irradiating the above constant amount of the light is lower, the reflectance ratio on the irradiated inspection area is lower. In this case, the irradiation amount of the light “z” for the inspection irradiated when the pattern inspection is conducted has to be enlarged.

As described above, even if the patterns are the same, when the inspection areas are different, there is a fluctuation in the reflectance ratio of the light caused by the difference of the thickness of the film. Therefore, the luminance of the inspection image is not necessarily constant, and it is important to adjust the amount of the light in order to conduct the pattern inspection precisely.

Here, the correlative relationship of FIG. 6 can be obtained by setting a plurality of inspection areas 21 in one wafer or by setting a plurality of inspection areas 21 in a plurality of wafers in one lot or by setting a plurality of inspection areas 21 in a plurality of wafers in different lots. It is preferable that the inspection areas 21 are set at a plurality of locations where the thicknesses of the films are predicted to fluctuate in fabrication process, such as the center side of the wafer and the outer side of the wafer in order to obtain the correlative relationship based on as many thicknesses of the films as possible. In these locations, the pattern defects tend to occur. Furthermore, it is possible to preliminarily form a plurality of patterns each of which has a different thickness of the film on the wafer 101 to obtain the correlative relationship.

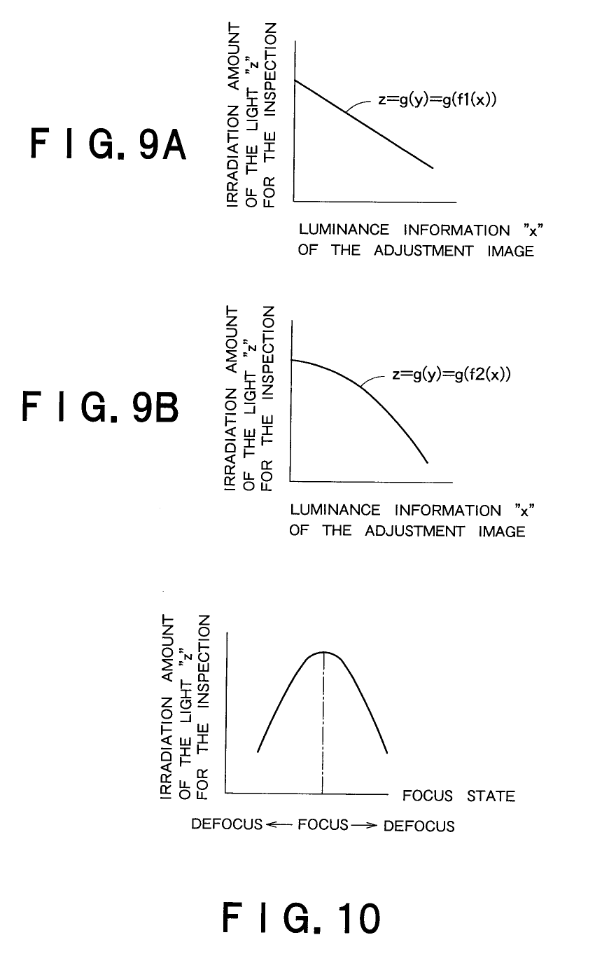

Then, the light amount adjuster 6 calculates a correlative relationship between the luminance information “x” of the adjustment image and the irradiation amount of the light “z” for the inspection based on the each correlative relationship obtained by step 511 and S12 (step S13). FIGS. 9A and 9B are graphs showing examples of the correlative relationships between the luminance information “x” of the adjustment image and the irradiation amount of the light “z” for the inspection. In FIGS. 9A and 9B, the horizontal axis is the luminance information “x” of the adjustment image, and the vertical axis is the irradiation amount of the light “z” for the inspection. The graph of FIG. 9A is obtained by combining the graph of FIG. 5A and that of FIG. 6. The graph of FIG. 9B is obtained by combining the graph of FIG. 5B and that of FIG. 6 as well. More specifically, the relationship between “x” and “z” can be obtained by following equations (1) and (2), respectively.

z=g(y)=g(f1(x)) (1)

z=g(y)=g(f2(x)) (2)

The graphs of FIGS. 9A and 9B show that as the luminance information “x” of the adjustment image is larger, the irradiation amount of the light “z” for the inspection is set to be smaller. In accordance with the correlative relationship, the light amount adjuster 6 calculates the amount of the light to be irradiated for the pattern inspection (irradiation amount of the light for the test) “z” from the luminance information “x” of the adjustment image obtained by irradiating the above constant amount of the light on the wafer 101. Therefore, the pattern inspection can be conducted while keeping the luminance information “y” of the inspection image always constant, independent of the thickness of the film of the inspection area 21, that is, the reflectance ratio of the light.

Here, the step S11 to S13 corresponds to first to third correlative relation ship obtaining parts.

As described above, the light amount adjuster 6 stores the correlative relationship between the luminance information “x” of the adjustment image and the irradiation amount of the light “z” for the inspection in the memory 7 (step S2 of FIG. 2). More specifically, a set of some certain luminance information “x” of the adjustment image on the graph of FIG. 6 and corresponding irradiation amount of the light “z” for the inspection are stored in the memory 7. Then, the pattern inspection device 100 starts the pattern inspection. Hereinafter, the processing procedure of the pattern inspection will be explained.

The light irradiator 1 irradiates the adjustment area 22 (step S3) with the above constant amount of the light. Then, the light amount adjuster 6 obtains the luminance information “x” of the adjustment image (step S4) to calculate the irradiation amount of the light “z” for the inspection in accordance with the correlative relationship of FIGS. 9A and 9B stored in the memory 7 (step S5). More specifically, if the irradiation amount of the light “z” for the inspection corresponding to the luminance information “x” of the adjustment image obtained at step S4 is stored in the memory 7, the light amount adjuster 6 reads out the irradiation amount of the light “z” for the test. If the irradiation amount of the light “z” for the inspection corresponding to the luminance information “x” of the adjustment image has not been stored in the memory 7, the light amount adjuster 6 reads out the irradiation amount of the light “z” for the inspection corresponding to the neighboring luminance information “x” of the adjustment image from the memory 7 and performs interpolation processing to calculate the irradiation amount of the light “z” for the inspection corresponding to the luminance information “x” of the adjustment image.

The light amount adjuster 6 adjusts the light irradiator 1 so that the amount of the light irradiated by the irradiator 1 gets equal to the irradiation amount of the light “z” for the inspection (step S6). Then, the light irradiator 1 irradiates the inspection area 21 with the light of the irradiation amount of the light “z” for the test, and the tester 3 conducts the pattern inspection based on the inspection image generated by the pickup part 2 for inspection (step S7).

Here, the light amount adjuster 6 can keep an approximate equation expressing the correlative relationship between the luminance information “x” of the adjustment image and the irradiation amount of the light “z” for the inspection at step S2, and the light amount adjuster 6 can calculate the irradiation amount of the light “z” for the inspection corresponding to the luminance information “x” of the adjustment image in accordance with the approximate equation at step S5. In this case, a logic circuit for operating the approximate equation may be provided instead of the memory 7.

Furthermore, the focus adjustment and the light-amount adjustment are performed in parallel, which is not shown in FIG. 2. Therefore, it is unclear whether or not the adjustment image is in focus when the light amount adjuster 6 obtains the luminance information “x” of the adjustment image. However, in general, the image is not out of focus so much. Even if the image is out of focus, the luminance information “x” of the adjustment image which is substantially equal to the case in focus can be obtained. Therefore, the pattern inspection is affected a little. Here, when the moving speed of the wafer 101 is slow or when the focus adjustment can be performed with high speed, the focus adjustment is performed firstly, and then the light-amount adjustment can be performed in the in-focus state. Furthermore, the luminance information “x” of the adjustment image depending on the focus state can be obtained, as explained below.

FIG. 10 is a graph showing an example of a relationship between the focus state and the luminance information “x” of the adjustment image. FIG. 10 shows that the luminance information “x” of the adjustment image becomes large when the adjustment image is in focus, however as the adjustment image is out of focus, the luminance information “x” of the adjustment image becomes small. The focus adjuster 5 obtains the relationship of FIG. 10 preliminarily and obtains both of the luminance information “x” of the adjustment image and the focus state at step S4 of FIG. 2. Furthermore, the focus adjuster 5 corrects the luminance information “x” of the adjustment image depending on the focus state to transmit the corrected luminance information “x” of the adjustment image to the light amount adjuster 6. Therefore, the light amount adjuster 6 can obtain the luminance information “x” of the adjustment image more precisely in consideration of the focus state.

The present embodiment assumes that the focus adjustment, the light-amount adjustment and the following pattern inspection are performed while moving the wafer 101 constantly. As mentioned above, the adjustment area 22 is located ahead of the inspection area 21 in the moving direction on the wafer 101.

Therefore, even if the irradiation direction of the light irradiated by the light irradiator 1 is constant, the light can be irradiated on the adjustment area 22 at step S3 and on the inspection area 21 at step S7. In the present embodiment, the focus adjustment and the light-amount adjustment (step S6) are performed while the irradiated light moves from the adjustment area 22 to the inspection area 21. Therefore, it is unnecessary to stop the wafer 101 for the adjustments, and the pattern inspection can be conducted in short time, thereby improving the throughput of the pattern inspection.

As described above, in the first embodiment, the correlative relationship between the luminance information “x” of the adjustment image and the irradiation amount of the light “z” for the inspection is obtained preliminarily before conducting the pattern inspection, and the irradiation amount of the light “z” for the inspection corresponding to the luminance information “x” of the adjustment image is set in accordance with the correlative relationship when conducting the pattern inspection. Therefore, the fluctuation of the luminance information of the inspection image caused by the thickness of the film on the inspection area 21 can be suppressed. Because of this, the optimum irradiation amount of the light “z” for the inspection can be set, and the detection missing of the pattern defects and false defects do not occur, thereby conducting the pattern inspection precisely. Namely, in this present embodiment, by monitoring the amount of the irradiated light used for the focus adjustment and feeding back the amount of the light on the pattern inspection, the inspection can be conducted with optimum amount of the light in real time, thereby conducting a high sensitivity inspection. Furthermore, because the pickup part 4 for adjustment, which is used also for the focus adjustment, is used for the light-amount adjustment, it is unnecessary to provide another pickup parts used only for the light-amount adjustment. Therefore, the preferable light-amount adjustment can be conducted while avoiding enlargement of the device and increase of the cost.

### Second Embodiment

Specific examples for implementing the pattern inspection device 100 of FIG. 1 will be described in following embodiments.

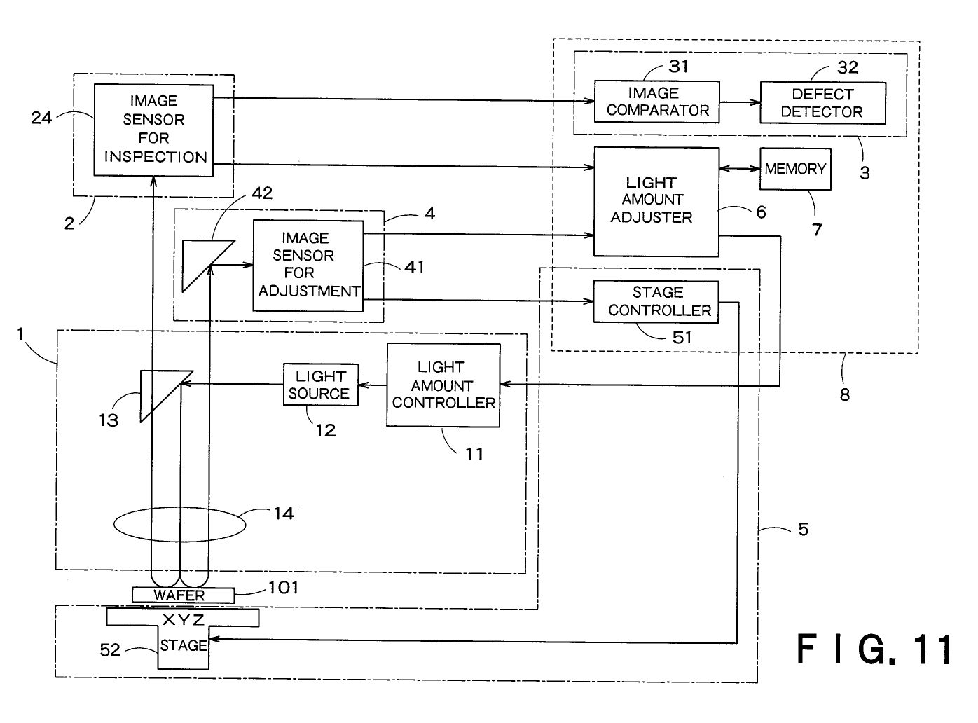

FIG. 11 is a schematic diagram showing one example of a pattern inspection system having a pattern inspection device 100 according to a second embodiment of the present invention. In FIG. 11, parts common to those of FIG. 1 have common reference numerals, respectively. The light irradiator 1 has a light amount controller 11, a light source 12, a half mirror 13, and an objective lens 14. The pickup part 2 for inspection has an image sensor 24 for inspection. The tester 3 has an image comparator 31 and a defect detector 32. The pickup part 4 for adjustment has an image sensor 41 for adjustment and a mirror 42. The focus adjuster 5 has a stage controller 51 and an XYZ stage 52. The tester 3, the stage controller 51, the light amount adjuster 6, and the memory 7 are included in a computer 8 in the example of FIG. 11.

FIG. 11 shows an example of adopting a TTL (Through the Lens) system using the same light source 12 for both adjustments of the focus and the pattern inspection.

The processing operations of the focus adjustment and the light-amount adjustment will be described below. The light irradiated by the light source 12 is reflected on the half mirror 13 and is incident into the adjustment area 22 on the wafer 101. The light reflected on the wafer 101 is collected by the objective lens 14 and picked up by the image sensor 41 for adjustment through the mirror 42. The stage controller 51 performs the focus adjustment by adjusting the height of the XYZ stage 52 based on the adjustment image picked up by the image sensor 41 for adjustment.

Furthermore, the light amount adjuster 6 obtains the luminance information “x” of the adjustment image. In addition, the light amount adjuster 6 calculates the irradiation amount of the light “z” for the inspection irradiated by the light source 12 when conducting the pattern inspection in accordance with the preliminarily obtained correlative relationship between the luminance information “x” of the adjustment image and the irradiation amount of the light “z” for the test, as described above.

On the other hand, the processing operation of the pattern inspection will be described below. The light amount adjuster 6 adjusts the light amount controller 11 so that the amount of the light irradiated by the light source 12 gets equal to the irradiation amount of the light “z” for the test. The amount of the light is adjusted by adjusting the amount of current flowing to the light source 12 for example. The light irradiated by the light source 12 is reflected on the half mirror 13 and is incident into the inspection area 21 on the wafer 101. The light reflected on the wafer 101 is collected by the objective lens 14 and picked up by the image sensor 24 for inspection. The image comparator 31 compares the image picked up by the image sensor 24 for inspection with a reference image and the defect detector 32 determines whether or not there are defects according to the comparison result. In the case where a plurality of the inspection areas are provided on a chip, an image of the neighboring inspection area is set as the reference image (Cell to Cell system). In the case where only an inspection area is provided on a chip, an image of the inspection area of the neighboring chip is set as the reference image (Die to Die system).

Here, type of the light irradiated by the light source 12 is not limited. The light source 12 can be a ramp light having a plurality of wavelength bands (e.g. wavelength bands of 250 to 600 nm) or can be a laser light having a signal wavelength. Furthermore, the image sensor 24 for inspection and the image sensor 41 for adjustment can be CMOS (Complimentary Metal Oxide Semiconductor) image sensors or can be CCD (Charge Coupled Device) cameras.

As described above, the same light source 12 is used for both focus adjustment and the light-amount adjustment, and the pattern inspection. Therefore, the precise light-amount adjustment can be performed while largely reducing the cost of the pattern inspection device 100.

### Third Embodiment

In the second embodiment, the same light source 12 is used for both the focus adjustment and the light-amount adjustment, and the pattern inspection. However, a third embodiment described hereinafter uses two light sources, one of which is used for the focus adjustment and the light-amount adjustment, and the other of which is used for the pattern inspection.

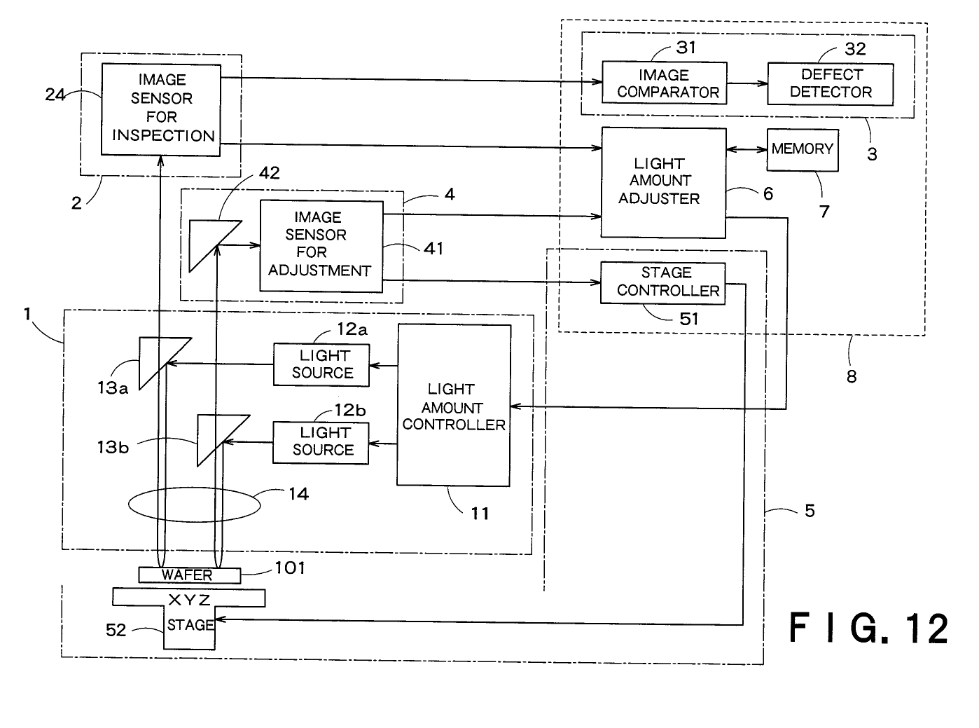

FIG. 12 is a schematic diagram showing a pattern inspection system having a pattern inspection device 100 according to the third embodiment of the present invention. In FIG. 12, parts common to those of FIG. 11 have common reference numerals, respectively. Hereinafter, different parts from FIG. 11 will be mainly described. The light irradiator 1 has a light amount controller 11, a light source 12a for inspection, a light source 12b for adjustment, a half mirror 13a (second light path generator), and a half mirror 13b (first light path generator).

FIG. 12 adopts “Out of the axis system” using separate light sources, one of which is used for focus adjustment and the light-amount adjustment, and the other of which is used for the pattern inspection.

When the focus adjustment and the light-amount adjustment are performed, the constant amount of the light irradiated by the light source 12b for adjustment is reflected on the half mirror 13b and is incident into the adjustment area 22 on the wafer 101. Then, as well as FIG. 11, the focus adjuster 5 adjusts the focus, and the light amount adjuster 6 calculates the irradiation amount of the light “z” for the test.

When the pattern inspection is conducted, the light amount adjuster 6 adjusts the light amount controller 11 so that the amount of the light irradiated by the light source 12a gets equal to the irradiation amount of the light “z” for the test. The light irradiated by the light source 12a for inspection is reflected on the half mirror 13a and incident into the inspection area 21 on the wafer 101. Then, the tester 3 conducts the pattern inspection based on the inspection image as well as FIG. 11.

As described above, in the third embodiment, because the light source for the focus adjustment and the light-amount adjustment and the light source for the pattern inspection are used separately from each other, it is possible to independently adjust the irradiation angle from the light source 12a for inspection and light source 12b for adjustment and/or the locations of the half mirrors 13a and 13b. Therefore, degree of freedom of setting locations of the adjustment area 22 and the inspection area 21 becomes large and the distance therebetween can be set larger than FIG. 11. As a result, from when the light amount adjuster 6 obtains the luminance information “x” of the adjustment image until the pattern inspection is started, enough time can be secured to perform the focus adjustment and the light-amount adjustment, thereby performing the focus adjustment and the light-amount adjustment precisely. Furthermore, because the moving speed of the wafer 101 can be set fast, the throughput of the pattern inspection improves.

Here, because the reflectance ratio also depends on the wavelength of the light source, it is preferable that the wavelength of the light source 12a for inspection and the light source 12b for adjustment are the same in the case of FIG. 12. When the pattern inspection is conducted with laser light, the inspection cost of FIG. 12, where two light sources are used, does not increase so much because the laser light source is cheaper than ramp light source. Therefore, the system of FIG. 12 is more suitable because the above effect is achieved. Contrarily, when the pattern inspection is conducted with ramp light, the system of FIG. 11 is more suitable because the inspection cost increases when the expensive two ramp sources are used.

### Fourth Embodiment

A fourth embodiment, which will be described hereinafter, is a combination of systems of FIG. 11 and FIG. 12. The same light source 12 is used for both the focus adjustment and the light-amount adjustment, and the pattern inspection, and a light for the light-amount adjustments and a light for the pattern inspection are generated by half mirrors.

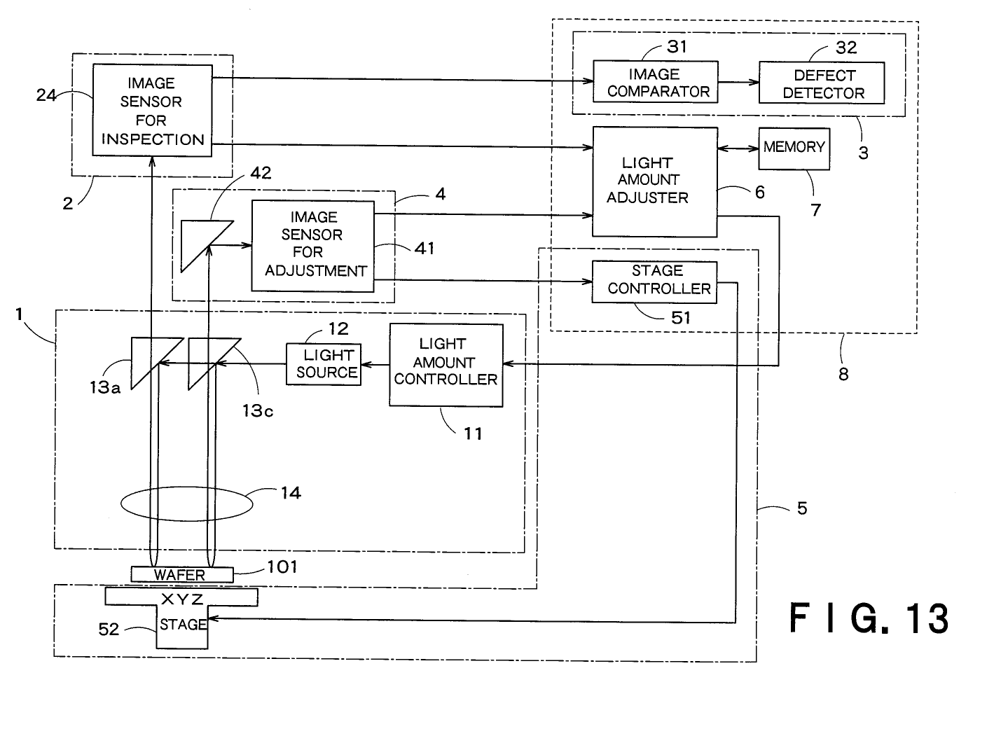

FIG. 13 is a schematic diagram showing a pattern inspection system having a pattern inspection device 100 according to the fourth embodiment of the present invention. In FIG. 13, parts common to those of FIG. 12 have common reference numerals, respectively. Hereinafter, different parts from FIG. 12 will be mainly described. The light irradiator 1 has a light amount controller 11, a light source 12, a half mirror 13a (first light path generator), and a half mirror 13c (second light path generator).

When the focus adjustment and the light-amount adjustment are performed, a part of light irradiated by the light source 12 and divided by the half mirror 13c is incident into the adjustment area 22 on the wafer 101. When the pattern inspection is conducted, another part of the light of the irradiation amount of the light “z” for the inspection which is irradiated by the light source 12 and passes through the half mirror 13c, is reflected on the 13a and incident into the inspection area 21.

As described above, in the fourth embodiment, the half mirror 13c generates the light for adjustment and the light for inspection from the light irradiated by the light source 12. Therefore, the cost of the pattern inspection device 100 can be reduced as well as FIG. 11 and the focus adjustment and the light-amount adjustment can be performed precisely as well as FIG. 12.

Each of the pattern inspection devices 100 shown in FIG. 11 to FIG. 13 is only an example, and various modifications can be conceivable. For example, in the FIG. 11 or the like, the light amount controller 11 directly controls the amount of the light irradiated by the light source 12 or the like. However, the amount of the light irradiated by the light source 12 or the like is set constant, and the amount of the light irradiated on the wafer 101 can be adjusted using ND (Neutral Density) filters. Furthermore, the computer 8 can have components other that those shown in FIG. 11 or the like, and the processing of the computer 8 can be executed by the distributed two or more computers.

At least a part of the pattern inspection device 100 explained in the above embodiments can be formed of hardware or software. When the pattern inspection device 100 is partially formed of the software, it is possible to store a program implementing at least a partial function of the pattern inspection device 100 in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the pattern inspection device 100 can be distributed through a communication line (including radio communication) such as the Internet etc. Furthermore, the program which is encrypted, modulated, or compressed can be distributed through a wired line or a radio link such as the Internet etc. or through the recording medium storing the program.

Although based on above description, those skilled in the art can figure out additional effects and variations of the present invention, the aspect of the present invention is not limited to the stated each embodiments. Various additions, alterations and partial deletions can be done to the present invention within the conceptualistic thought and purpose of the present invention drawn on the claims and the equivalents.

1. A pattern inspection device comprising:
a light irradiator configured to irradiate a light on an inspection area set in a pattern forming location on a semiconductor wafer and an adjustment area set different from the inspection area in association with the inspection area on the semiconductor wafer;
an image pickup part for inspection configured to pick up a light which is irradiated by the light irradiator and reflected on the inspection area to generate an inspection image;
a tester configured to conduct a pattern inspection of the semiconductor wafer based on the inspection image;
an image pickup part for adjustment configured to pick up a light which is irradiated by the light irradiator and reflected on the adjustment area to generate an adjustment image; and
a light amount adjuster configured to adjust an amount of the light irradiated on the inspection area by the light irradiator so as to reduce a fluctuation of a luminance of the inspection image due to a difference of a thickness of the pattern based on the adjustment image.

2. The device of claim 1 further comprising:
a correlative relationship obtaining part configured to obtain a correlative relationship between the luminance of the inspection image and the irradiation amount of the light irradiated by the light irradiator so as to reduce a fluctuation of the luminance of the inspection image due to the difference of the thickness of the pattern;
wherein the light amount adjuster adjusts the amount of the light irradiated by the light irradiator based on the luminance of the adjustment image and the correlative relationship.

3. The device of claim 2, wherein a plurality of the inspection areas and a plurality of the adjustment areas are provided on the semiconductor wafer,
the correlative relationship obtaining part comprising:
a first correlative relationship obtaining part configured to obtain a first correlative relationship between the luminance of the adjustment image and a luminance of the inspection image while varying an amount of light irradiated by the light irradiator on the inspection area and the adjustment area;
a second correlative relationship obtaining part configured to obtain a second correlative relationship between the luminance of the inspection image when the light irradiator irradiates the inspection area with a predetermined amount of light and the irradiation amount of the light irradiated by the light irradiator required in order to set a luminance of the inspection image of the inspection area to be a predetermined luminance independent of the thickness of the pattern, with regard to each of the plurality of the inspection areas; and
a third correlative relationship obtaining part configured to obtain a third correlative relationship between the luminance of the inspection image and the irradiation amount of the light irradiated by the light irradiator by combining the first and the second correlative relationships.

4. The device of claim 3, wherein the second correlative relationship obtaining part sets the predetermined luminance so as to avoid an occurrence of a detection missing of pattern defects and a false detect.

5. The device of claim 3, wherein the second correlative relationship obtaining part obtains the second correlative relationship with regard to plurality of the inspection areas where the thickness of the pattern is predicted to fluctuate.

6. The device of claim 1, further comprising:
a focus adjuster configured to perform focus adjustment of the adjustment image in parallel with a process of the light irradiator,
wherein the adjustment area is set ahead of the inspection area in moving direction of the semiconductor wafer so that a process of the light irradiator, a process of the focus adjuster, and a process of the tester are successively performed, while moving the semiconductor wafer.

7. The device of claim 6, wherein locations of the inspection area and the adjustment area are set in consideration of moving speed of the semiconductor wafer and a time required for the focus adjustment and the light-amount adjustment.

8. The device of claim 6, wherein the focus adjuster obtains a relationship between a focus state of the adjustment image and the luminance of the adjustment image preliminarily and corrects the adjustment image depending on the focus state, and
the light irradiator adjusts the irradiation amount of the light based on the corrected adjustment image.

9. The device of claim 1, wherein the light irradiator comprises a single light source configured to irradiate both the adjustment area and the inspection area with the light at different timings.

10. The device of claim 9, wherein the light irradiator comprises:
a first light path generator configured to irradiate the adjustment area with the light from the single light source and to lead a light reflected on the adjustment area to the image pickup part for adjustment; and
a second light path generator configured to irradiate the inspection area with the light from the single light source and to lead a light reflected on the inspection area to the image pickup part for inspection.

11. The device of claim 1, wherein the light irradiator comprises:
a light source for adjustment configured to irradiate the adjustment area with the light;
a light source for inspection configured to irradiate the inspection area with the light;
a first light path generator configured to irradiate the adjustment area with the light from the light source for adjustment and to lead a light reflected on the adjustment area to the image pickup part for adjustment; and
a second light path generator configured to irradiate the inspection area with the light from the inspection light source and to lead a light reflected on the inspection area to the image pickup part for inspection.

12. The device of claim 11, wherein wavelength of the light irradiated by the light source for adjustment and wavelength of the light irradiated by the light source for inspection are the same.

13. A pattern inspection method comprising:
irradiating a light on an inspection area set in a pattern forming location on a semiconductor wafer and an adjustment area set different from the inspection area in association with the inspection area on the semiconductor wafer;
picking up the irradiated light reflected on the inspection area to generate an inspection image;
conducting a pattern inspection of the semiconductor wafer based on the inspection image;
picking up the irradiated light reflected on the adjustment area to generate an adjustment image; and
adjusting an amount of the irradiated light so as to reduce a fluctuation of a luminance of the inspection image due to a difference of a thickness of the pattern based on the adjustment image.

14. The method of claim 13 further comprising:
obtaining a correlative relationship between the luminance of the inspection image and the irradiation amount of the irradiated light so as to reduce a fluctuation of the luminance of the inspection image due to the difference of the thickness of the pattern;
wherein upon adjusting the amount of the irradiated light, the amount of the irradiated light is adjusted based on the luminance of the adjustment image and the correlative relationship.

15. The method of claim 14, wherein a plurality of the inspection areas and a plurality of the adjustment areas are provided on the semiconductor wafer,
wherein upon obtaining the correlative relationship comprising:
obtaining a first correlative relationship between the luminance of the adjustment image and a luminance of the inspection image while varying an amount of light irradiated on the inspection area and the adjustment area;
obtaining a second correlative relationship between the luminance of the inspection image when a predetermined amount of light is irradiated on the inspection area and the irradiation amount of the irradiated light required in order to set a luminance of the inspection image of the inspection area to be a predetermined luminance independent of the thickness of the pattern, with regard to each of the plurality of the inspection areas; and
obtaining a third correlative relationship between the luminance of the inspection image and the irradiation amount of the irradiated light by combining the first and the second correlative relationships.

16. The method of claim 15, wherein upon obtaining the second correlative relationship, the predetermined luminance is set so as to avoid an occurrence of a detection missing of pattern defects and a false detect.

17. The method of claim 15, wherein upon obtaining the second correlative relationship, the second correlative relationship is obtained with regard to plurality of the inspection areas where the thickness of the pattern is predicted to fluctuate.

18. The method of claim 13, further comprising;
performing focus adjustment of the adjustment image in parallel with a process of the light-amount adjustment,
wherein the adjustment area is set ahead of the inspection area in moving direction of the semiconductor wafer so that the light-amount adjustment and the focus adjustment, and the pattern inspection are successively performed, while moving the semiconductor wafer.

19. The method of claim 18, wherein locations of the inspection area and the adjustment area are set in consideration of moving speed of the semiconductor wafer and a time required for the focus adjustment and the light-amount adjustment.

20. The method of claim 18, wherein upon performing focus adjustment, a relationship between a focus state of the adjustment image and the luminance of the adjustment image is obtained preliminarily and the adjustment image is corrected depending on the focus state, and
upon adjusting the amount of the irradiated light, the irradiation amount of the light is adjusted based on the corrected adjustment image.
